(19) United States
(12) Patent Application Publication
(10) Pub. No.: US 2021/0134189 A1
(43) Pub. Date: May 6, 2021

(54) CABLE SEAL (VARIANTS) AND SEALING METHOD (VARIANTS)

(71) Applicant: Alexandr LUBENSCHII, Chisinau (MD)

(72) Inventor: Alexandr LUBENSCHII, Chisinau (MD)

(21) Appl. No.: 16/474,577

(22) PCT Filed: Dec. 27, 2017
(86) PCT No.: PCT/MD2017/000008

§ 371 Date: Jun. 28, 2019

(30) Foreign Application Priority Data
Dec. 31, 2016 (MD) A 20160155

(51) Int. Cl. G09F 3/03

(52) U.S. Cl. CPC G09F 3/0352

(57) ABSTRACT

The invention relates to means for detecting unauthorized access to mobile and fixed warehouses and for protecting material assets stored therein against theft, and also for other similar purposes. A cable seal comprises a housing (1) containing a longitudinal blind axial channel (2) in which the end of a cable (3) is rigidly fastened, two axial channels (4) and (5) with locking mechanisms (6) and (7) for receiving the cable (3), and a loop A situated in the lower portion between channels (4) and (5). The loop A is protected by a mechanism which blocks access thereto, consisting of transverse channels provided in lateral ledges of the seal, said channels slidably receiving a bolt (10) with locking elements (11) mounted on an inner portion for engagement with a ledge (12) provided in the lower portion of the seal. According to a second variant of the cable seal, the mechanism which blocks access to the loop A consists of a covering plate (10), one end of which is hingedly fastened to a lateral ledge (11); the other end of the covering plate (10) has mounted thereon a mechanism which blocks access to the loop A, having an elastic element with a catch (12) that engages with a ledge (13).

The invention relates to the means for detecting an unauthorized access to mobile and stationary warehouses, protection against theft of material assets stored therein as well as for other similar purposes.

There exists a seal protected by a cable in the housing of which there is a solid channel on one side where the end of the cable is encapsulated. Hereafter, as a result of blocking (sealing) of the product, the other end of the cable is passed through the inner portion of the second and third channels of the housing, equipped with locking mechanisms. After blocking of the cable, extended through the second and third channels of the housing the cable is placed in the lower portion of the housing of the seal forming a visually available loop (1) MD 3134 F1 2006.08.31.

Basing on the analysis of the practice of use of the seals protected by a cable and having two parallel locking mechanisms it was established that a disadvantage of such a design consisted in a possibility of pulling out of the cable by extrusion or by twisting it in and out of the locking mechanisms of a seal, to strengthen the contraction of a loop of the cable hidden inside the housing of the seal or laid on the housing. Basing on the above actions the diameter of the loop may be increased, significantly protruding beyond the perimeter of the seal. After increasing the size of the cable loop, having the intention to break the seal, the cable loop is stretched with special tools and attempts to pull the cable out of the seal are made. This design defect of the solid seal challenges the possibility of its use for sealing the items that require an increased level of reliability and property safety.

The problem this invention solves is to increase the sealing reliability providing an increased safety of material values.

The LOCKIN cable seal includes a housing with a longitudinal blind axial channel where the end of the cable is securely fixed and two axial channels with locking mechanisms to locate the cable inside. In the lower portion of the seal, between the axial channels, a loop is formed, protected by the side ledge of the seal. In the lower portion of the housing of the seal a mechanism is mounted that blocks the access to the loop, consisting of transverse channels made on the side ledge of the seal, where a sliding bolt with the locking elements is mounted which interlocks with the ledge available on the lower portion of the seal.

The cable seal where the locking elements are mounted on the inner portion of the bolt in the form of elastic arms in an indefinite number, arranged symmetrically, in the form of a fish bone.

The cable seal where the locking elements are mounted on the inner portion of the bolt in the two elastic arms arranged symmetrically whereas the lower portion of the bolt has a ledge.

The cable seal includes a housing with a longitudinal blind axial channel where the end of the cable is securely fixed and two axial channels with locking mechanisms to locate the cable inside. In the lower portion of the seal, between the axial channels, a loop is formed, protected by the side ledge of the seal. In the lower portion of the housing of the seal, a mechanism is mounted that blocks the access to the loop, consisting of a covering plate, one end of which is hingedly fixed by a side ledge, while at the second end of the covering plate a mechanism is mounted that blocks the access to the loop, consisting of an elastic element with a catch connected to the ledge available at the bottom of the seal.

The method of protection using a cable seal consists in a secure fastening of the cable end into the longitudinal blind axial channel of the seal while the second end of the cable is extended through the lugs of the object to be sealed and then extended through the axial channels with locking mechanisms forming a loop at the bottom of the seal between the axial channels. Blocking the only access to the loop of the seal cable is performed by pressing the extended bolt which, sliding along the transverse channels available on the lateral ledge of the seal, fixes due to its blocking elements mounted on the inner portion coupling with the ledge available on the lower portion of the seal, thus leaving no option for a subsequent unlocking of the bolt.

The protection method using a cable seal consists in a secure fastening of the cable end in the longitudinal blind axial channel of the seal whereas the second end of the cable is extended through the lugs of the object to be sealed; then, it should be extended through the axial channels with locking mechanisms, forming a loop at the bottom of the seal between the axial channels protected by the side ledge of the seal. Blocking the only access to the loop of the seal cable is performed by affecting the ledge available in the lower portion of the bolt which, sliding with its locking elements mounted on its inner portion, blocks the bolt leaving no option for its subsequent unlocking.

The protection method using a cable seal consists in secure fastening of the cable end in the longitudinal blind axial channel of the seal whereas the second end of the cable is extended through the lugs of the object to be sealed; then, it should be extended through the axial channels with locking mechanisms, forming a loop at the bottom of the seal between the axial channels protected by the side ledge of the seal. Blocking the only access to the cable loop of the seal is performed by affecting the covering plate until the catch of the covering plate is connected in the ledge of the mechanism blocking the access to the loop.

The technical result of the invention consists in the method of mandatory sealing and blocking of that portion of the cable seal where the cable loop is formed between the two channels where the locking mechanism of the sealing device is mounted.

This method of security provision with the help of this invention significantly increases the reliability of a cable seal.

The invention is presented on the schemes: FIG. 1-6, presenting:

FIG. 1.1—the cable seal with the bolt with the blocking elements in the rest position, in section;

FIG. 1.2—the cable seal with the bolt with blocking elements in the blocked position, in section;

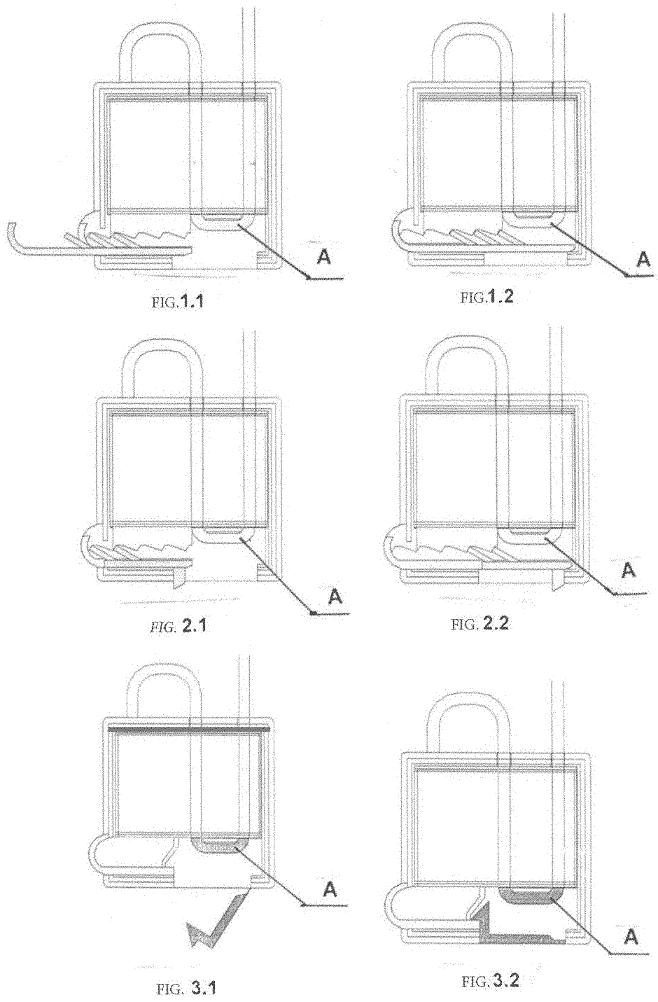

FIG. 2.1—the cable seal with the bolt with blocking elements in the rest position, in section;

FIG. 2.2—the cable seal with the bolt with blocking elements in the blocked position, in section;

FIG. 3.1—the cable seal with the covering plate with the catch and ledge in the rest position, in section;

FIG. 3.2—the cable seal with the covering plate with the catch and ledge in the blocked position, in section;

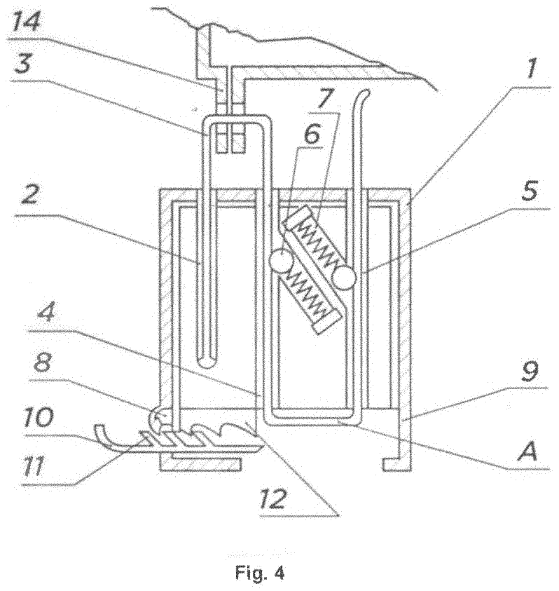

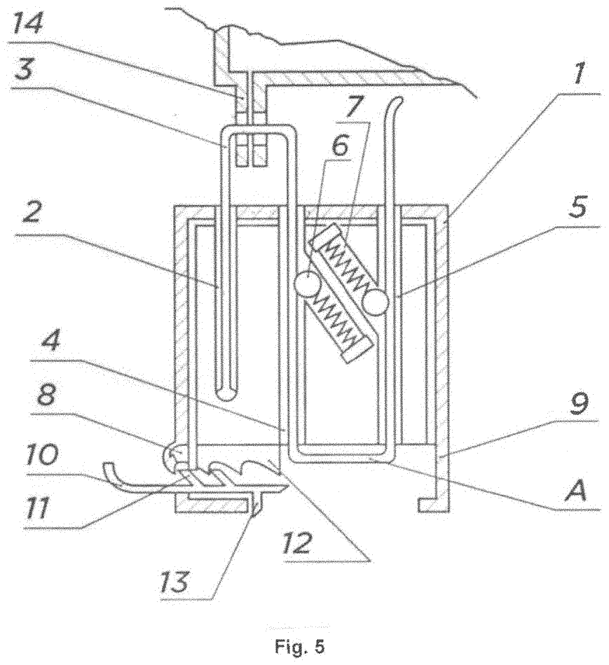

FIG. 4—the cable seal with a bolt, general view, in section;

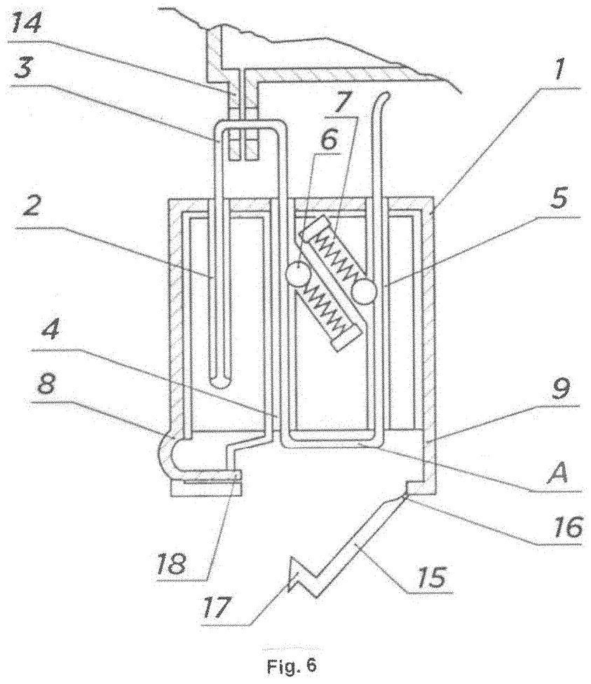

FIG. 5—the cable seal with a bolt with a ledge at the bottom, general view, in section;

FIG. 6—the cable seal with the covering plate, general view, in section.

The cable seal (FIGS. 1.1, 1.2 and 4), according to the first version, includes the housing 1, where the longitudinal blind axial channel 2 is located where the end of the cable 3 is securely fixed and two axial channels 4 and 5 with locking mechanisms 6 and 7 for the location of the cable inside of them. In the lower portion of the seal, between the axial channels 4 and 5, a loop is formed, protected by the side ledge 8 and 9 of the seal. In the lower portion of the housing 1 of the seal a mechanism is mounted blocking the access to the loop A consisting of the transverse channels made on the side ledge of the seal, where a sliding bolt 10 with the blocking elements 11 is mounted on the inner side which interlock with the ledge 12 available on the lower portion of the seal.

The locking elements 11 of the cable seal are mounted in the inner portion of the bolt 10 in the form of elastic arms in an indefinite number, arranged symmetrically, in the form of a fish bone.

In addition, the blocking elements 11 of the cable seal (FIGS. 2.1, 2.2 and 5) can be mounted in the inner portion of the bolt 10 in two elastic symmetrically arranged arms, while in the lower portion of the bolt 10 there is a ledge for the bolt 10 functioning.

The cable seal (FIGS. 3.1, 3.2 and 6), according to the second version, includes a housing 1 with a longitudinal blind axial channel 2, where the end of the cable 3 is securely fixed and two axial channels 4 and 5 with locking mechanisms 6 and 7 for the location of the cable 3 inside of them; however, in the lower portion of the seal, between the axial channels 4 and 5 there is a loop A protected by the side ledge 8 and 9 of the seal. In the lower portion of the housing 1 of the seal a mechanism for blocking the access to the loop A is mounted, consisting of a covering plate 10, the end of which is pivoted by the side ledge 11, while on the other end of the cover plate 10 there is a mechanism for blocking the access to the loop A, consisting of an elastic element with a catch 12, connected to the ledge 13, located at the bottom of the seal.

The protection method using a cable seal (FIGS. 1.1, 1.2 and 4), according to the first version, consists of a secure fastening of the end of the cable 3 in the longitudinal blind axial channel 2 of the seal and the second end of the cable 3 is extended through the lugs 14 of the object to be sealed; then it is extended through the axial channels 4 and 5 with the locking mechanisms 6 and 7, forming at the bottom of the seal, between the axial channels, the loop A. Blocking the only access to the loop A of the cable 3 of the seal from an external influence and unauthorized opening is performed by pressing the stretched bolt 10, which, sliding along the transverse channels available on the side ledge of the seal, with its blocking elements 11 mounted on the inner portion, interlocking with the ledge 12 available on the bottom of the seal, are fixed, leaving no option for subsequent unlocking of the bolt 10.

The protection method using a cable seal (FIGS. 2.1, 2.2 and 5) consists in a secure fastening of the end of the cable 3 into the longitudinal blind axial channel 2 of the seal, while the second end of the cable 3 is extended through the lugs 14 of the object to be sealed; then it is extended through the axial channels 4 and 5 with locking mechanisms 6 and 7, forming at the bottom of the seal, between the axial channels 4 and 5, a loop protected by the side ledges 8 and 9 of the seal. The locking mechanisms 6 and 7 do not allow to pull out the cable 3 by means of an external action or unauthorized opening. Blocking the only access to the loop A of the cable 3 of the seal is performed by the action over the ledge 13 available in the lower portion of the bolt 10, which, sliding by its locking elements 11 mounted on the inner portion, block the bolt 10, leaving no option of its subsequent unblocking.

The method related to the use of a cable seal (FIGS. 3.1, 3.2 and 6), according to the second version, consists in a secure fastening of the end of the cable 3 in the longitudinal blind axial channel 2 of the seal while the second end of the cable 3 is extended through the lugs 14 of the object to be sealed and then it is extended through the axial channels 4 and 5 with locking mechanisms 6 and 7, forming at the bottom of the seal, between the axial channels 4 and 5, the loop A, protected by side ledges 8 and 9 of the seal. Blocking the only access to the loop of the cable 3 of the seal from an external action and unauthorized opening is performed by the impact on the covering plate 10 until the bolt 12 of the covering plate 10 is not connected to the ledge 13 of the locking mechanism of the loop A access.

This cable seal will provide an increased protection of the sealed property and protect against an access in housing of external action and unauthorized opening, not allowing the impact with sharp objects over the loop A of the cable which is formed between the two channels where the locking mechanisms of the sealing device are located.

What is claimed is:

1. The LOCKIN cable seal includes the housing (1), with the following portions, being located in parallel: a longitudinal blind channel (2) for a secure fastening of the end of the cable (3) and two longitudinal through channels (4 and 5) for placement and fastening of the cable (3) using locking mechanisms (6 and 7) forming in the upper portion of the housing (1), between the blind channel (2) and through channel (4),the loop for sealing the object (14), to be sealed and—in the lower portion of the housing, between the through channels (4 and 5)—of another loop (A); along the perimeter of the lower side of the housing (1) there are end ledge on the inner walls of which there is a longitudinal groove and side “L” shaped ledges (8 and 9) in one of which (8) there is a hole; the mechanism for blocking the access to the loop (A), consists of a bolt (10) with a locking mechanism (11) mounted with the possibility of sliding inside the longitudinal grooves of the end ledge available on the lower portion of the housing (1) and blocking the gap formed between the ends of the side and end ledge (8 and 9); on the lower portion of the housing (1) there are ribs (12) for coupling with the ribs of the locking mechanism (11).

2. The cable seal, according to Item 1, where the ribs of the mechanism (11) are made of an elastic material in an amount of not less than 2 are arranged symmetrically, in the form of a fish bone.

3. The cable seal, according to item 1, where the lower portion of the bolt (10) has a ledge (13).

4. The cable seal includes the housing (1) housing the longitudinal blind channel (2) for a secure fastening of the cable (3) and two through channels (4 and 5) for the placement and fastening of the cable in side of them by means of locking mechanisms (6 and 7), forming in the upper portion of the housing (1), between the blind channel (2) and the through channel (4), the loop for sealing the object (14) to be sealed and—at the bottom of the housing, between the through channels (4 and 5)—another loop (A); along the perimeter of the lower side of the housing (1) there are end ledge on the inner walls of which there is a longitudinal groove and side “L” shaped ledge (8 and 9); the mechanism for blocking the access to the loop (A) consisting of a cover (15), hingedly fixed at the end (16) of the side ledge (9) and equipped with an elastic catch (17) for interlocking with the coupling element (18), mounted on the end of the side ledge (8).

5. The method of sealing with the use of a cable seal is determined according to Items 1-3, consisting in the secure fastening of the cable end (3) in the longitudinal blind axial channel (2) of the seal, while the second end of the cable (3) is extended through the lugs of the object (14) to be sealed and through the longitudinal through channels (4) and (5) and fixed by means of locking mechanisms (6 and 7) mounted inside of them; blocking the access to the loop (A) formed between the through channels (4 and 5) by affecting the bolt (10) with its simultaneous sliding inside the longitudinal channels of the end ledge until it contacts a fixed gear-wheel between the ribs of the mechanism with the catch (11) and the ribs (12) on the housing (1) and closing of the gap formed between the ends of the side and end ledges (8 and 9).

6. The method of protection with the use of a cable seal, as defined in Item 4, consists in secure fastening of the cable end (3) in the longitudinal blind channel (2), whereas the second end should be extended through the lugs of the object (14) to be sealed, and through the longitudinal through channels (4 and 5), and fixed by the locking mechanisms (6 and 7) of the cable (3) in side of them; blocking the access to the loop (A) formed between the channels (4 and 5), by pressing the cover (15) until the coupling of the catch (17) with a locking element (18) becomes non-detachable and closing the gap formed between the ends of the side and end ledge (8 and 9).
